(19) United States
(12) Patent Application Publication
(10) Pub. No.: US 2025/0209260 A1
(43) Pub. Date: Jun. 26, 2025

(54) TARGET PUSHING METHOD AND APPARATUS, AND COMPUTER-READABLE STORAGE MEDIUM

(71) Applicant: Beijing Zitiao Network Technology Co., Ltd., Beijing (CN)

(72) Inventors: Chuanqi JING, Beijing (CN); Qiuyi ZHANG, Beijing (CN); Xingwen ZHANG, Beijing (CN)

(21) Appl. No.: 18/936,751

(22) Filed: Nov. 4, 2024

(30) Foreign Application Priority Data
Dec. 20, 2023 (CN) 202311760154.6

(51) Int. Cl. G06F 40/186; G06T 11/60

(52) U.S. Cl. CPC G06F 40/186; G06T 11/60

(57) ABSTRACT

The present disclosure relates to a target pushing method and apparatus, and a computer-readable storage medium, and relates to the field of computer technologies. The target pushing method includes: obtaining pushing information of at least one to-be-pushed target; determining a pushing page template based on pushing characteristics of the pushing information; and generating a pushing page of the at least one to-be-pushed target based on the pushing information and the pushing page template.

### CROSS-REFERENCE TO RELATED APPLICATION

This application is based on and claims the benefit of priority to the Chinese patent application No. 202311760154.6 filed on Dec. 20, 2023, which is hereby incorporated by reference in its entirety into the present application.

### TECHNICAL FIELD

The present disclosure relates to the field of computer technologies, and in particular, to a target pushing method and apparatus, and a computer-readable storage medium.

### BACKGROUND

In a scenario of pushing a target such as an article or a service to a user by using a network technology, it is often necessary to initiate a pushing topic of the target. The pushing topic may include a related description of the target.

In the related art, a pusher needs to manually edit a pushing page for the pushing topic to present related information of the pushed target to the user.

### SUMMARY

According to some embodiments of the present disclosure, a target pushing method is provided, comprising: obtaining pushing information of at least one to-be-pushed target: determining a pushing page template based on a pushing characteristic of the pushing information; and generating a pushing page of the at least one to-be-pushed target based on the pushing information and the pushing page template.

In some embodiments, different pushing characteristics prompt different attribute features of the at least one to-be-pushed target.

In some embodiments, the attribute features comprise at least one of a type to which the at least one to-be-pushed target belongs, a target producer of the at least one to-be-pushed target, an audience group aimed at by the at least one to-be-pushed target, or number information of the at least one to-be-pushed target.

In some embodiments, the determining a pushing page template comprises: in response to the pushing characteristic being configured to prompt that the at least one to-be-pushed target belongs to a same type, determining a text template as the pushing page template, the text template being configured to display text description information of the at least one to-be-pushed target.

In some embodiments, the text description information is generated based on a keyword in the pushing information.

In some embodiments, the determining a pushing page template comprises: in response to the pushing characteristic being configured to prompt that the at least one to-be-pushed target belongs to a same target producer or the at least one to-be-pushed target is aims at audience groups of a same type, determining an image template as the pushing page template, the image template being configured to display image description information of the at least one to-be-pushed target.

In some embodiments, the generating a pushing page of the at least one to-be-pushed target comprises: in response to a number of targets displayed by the image template being less than a number of the at least one to-be-pushed target, selecting a specified number of targets from the at least one to-be-pushed target, the specified number being less than or equal to the number of targets displayed by the image template; and generating the pushing page based on image description information of the specified number of targets and the page template.

In some embodiments, the generating the pushing page comprises: generating a background image based on the at least one to-be-pushed target by using a machine learning model; and generating the pushing page based on the background image, the image description information of the at least one to-be-pushed target, and the page template.

In some embodiments, the image template comprises a single-object template being configured to display image description information of any one of the at least one to-be-pushed target and a multi-object template being configured to display image description information of a plurality of targets in the at least one to-be-pushed target.

In some embodiments, the determining a pushing page template comprises: in response to the at least one to-be-pushed target being a single to-be-pushed target, determining the single-object template as the pushing page template; and in response to the at least one to-be-pushed target being a plurality of to-be-pushed targets, determining the multi-object template as the pushing page template.

In some embodiments, the determining a pushing page template comprises: in response to the pushing characteristic being configured to prompt that the at least one to-be-pushed target comprises a plurality of to-be-pushed targets, determining a list template as the pushing page template, the list template being configured to display a list of the plurality of to-be-pushed targets.

In some embodiments, the generating a pushing page of the at least one to-be-pushed target comprises: prompting a user to select the pushing page template in a template selection interface; and in response to a selection operation of the user for the pushing page template in the template selection interface, generating the pushing page based on the pushing information and the pushing page template.

In some embodiments, the template selection interface is configured to display a plurality of candidate page templates, the plurality of candidate page templates comprise the pushing page template, and the pushing page template is highlighted.

In some embodiments, the template selection interface is configured to display the plurality of candidate page templates based on a number of the at least one to-be-pushed target.

In some embodiments, the template selection interface is configured to perform at least one of the following: display at least one of a single-object template or a text template in response to the at least one to-be-pushed target being a single to-be-pushed target: or display at least one of a multi-object template or a list template in response to the at least one to-be-pushed target being a plurality of to-be-pushed targets.

In some embodiments, the template selection interface is configured to perform at least one of the following: in response to the at least one to-be-pushed target being the single to-be-pushed target, the plurality of candidate page templates do not comprise the multi-object template, or at least one of the single-object template or the text template is highlighted in the plurality of candidate page templates.

In some embodiments, the template selection interface is configured to perform at least one of the following: in response to a number of the plurality of to-be-pushed targets being less than a threshold, the multi-object template is highlighted in the plurality of candidate page templates: or in response to the number of the plurality of to-be-pushed targets being greater than or equal to the threshold, the list template is highlighted in the plurality of candidate page templates.

In some embodiments, the generating a pushing page of the at least one to-be-pushed target comprises: generating a candidate pushing page of the at least one to-be-pushed target based on the pushing information and the pushing page template; and generating the pushing page based on edit information provided by the user in an edit interface of the candidate pushing page.

In some embodiments, the edit information comprises at least one of text information input by the user in the edit interface or candidate edit information selected by the user.

According to some other embodiments of the present disclosure, a target pushing apparatus is provided, comprising: an obtaining unit configured to obtain pushing information of at least one to-be-pushed target: a determining unit configured to determine a pushing page template based on a pushing characteristic of the pushing information; and a generation unit configured to generate a pushing page of the at least one to-be-pushed target based on the pushing information and the pushing page template.

In some embodiments, different pushing characteristics prompt different attribute features of the at least one to-be-pushed target.

In some embodiments, the attribute features comprise at least one of a type to which the at least one to-be-pushed target belongs, a target producer of the at least one to-be-pushed target, an audience group aimed at by the at least one to-be-pushed target, and number information of the at least one to-be-pushed target.

In some embodiments, the determining unit determines, in response to the pushing characteristic being configured to prompt that the at least one to-be-pushed target belongs to a same type, a text template as the pushing page template, and the text template is configured to display text description information of the at least one to-be-pushed target.

In some embodiments, the text description information is generated based on a keyword in the pushing information.

In some embodiments, the determining unit determines, in response to the pushing characteristic being configured to prompt that the at least one to-be-pushed target belongs to a same target producer or the at least one to-be-pushed target is aimed at audience groups of a same type, an image template as the pushing page template, and the image template is configured to display image description information of the at least one to-be-pushed target.

In some embodiments, the generation unit selects, in response to a number of targets displayed by the image template being less than a number of the at least one to-be-pushed target, a specified number of targets from the at least one to-be-pushed target, the specified number being less than or equal to the number of targets displayed by the image template; and generates the pushing page based on image description information of the specified number of targets and the page template.

In some embodiments, the generation unit generates a background image based on the at least one to-be-pushed target by using a machine learning model, and generates the pushing page based on the background image, the image description information of the at least one to-be-pushed target, and the page template.

In some embodiments, the image template comprises a single-object template being configured to display image description information of any one of the at least one to-be-pushed target and a multi-object template being configured to display image description information of a plurality of targets in the at least one to-be-pushed target.

In some embodiments, the determining unit determines, in response to the at least one to-be-pushed target being a single to-be-pushed target, the single-object template as the pushing page template; and determines, in response to the at least one to-be-pushed target being a plurality of to-be-pushed targets, the multi-object template as the pushing page template.

In some embodiments, the determining unit determines, in response to the pushing characteristic being configured to prompt that the at least one to-be-pushed target comprises a plurality of to-be-pushed targets, a list template as the pushing page template, and the list template is configured to display a list of the plurality of to-be-pushed targets.

In some embodiments, the generation unit prompts a user to select the pushing page template in a template selection interface; and generates the pushing page based on the pushing information and the pushing page template in response to a selection operation of the user for the pushing page template in the template selection interface.

In some embodiments, the template selection interface is configured to display a plurality of candidate page templates, the plurality of candidate page templates comprise the pushing page template, and the pushing page template is highlighted.

In some embodiments, the template selection interface is configured to display the plurality of candidate page templates based on a number of the at least one to-be-pushed target.

In some embodiments, the template selection interface is configured to perform at least one of the following: display at least one of a single-object template or a text template in response to the at least one to-be-pushed target being a single to-be-pushed target: or display at least one of a multi-object template or a list template in response to the at least one to-be-pushed target being a plurality of to-be-pushed targets.

In some embodiments, the template selection interface is configured to perform at least one of the following: in response to the at least one to-be-pushed target being the single to-be-pushed target, the plurality of candidate page templates do not comprise the multi-object template, or at least one of the single-object template and the text template is highlighted in the plurality of candidate page templates.

In some embodiments, the template selection interface is configured to perform at least one of the following: in response to a number of the plurality of to-be-pushed targets being less than a threshold, the multi-object template is highlighted in the plurality of candidate page templates: or in response to the number of the plurality of to-be-pushed targets being greater than or equal to the threshold, the list template is highlighted in the plurality of candidate page templates.

In some embodiments, the generation unit generates a candidate pushing page of the at least one to-be-pushed target based on the pushing information and the pushing page template; and generates the pushing page based on edit information provided by the user in an edit interface of the candidate pushing page.

In some embodiments, the edit information comprises at least one of text information input by the user in the edit interface or candidate edit information selected by the user.

According to some further embodiments of the present disclosure, a target pushing apparatus is provided, comprising: a memory; and a processor coupled to the memory; the processor being configured to execute the target pushing method in any one of the above embodiments based on instructions stored in the memory apparatus.

According to some further embodiments of the present disclosure, a non-transitory computer-readable storage medium is provided, having a computer program stored thereon, wherein the program, when executed by a processor, causes the target pushing method in any one of the above embodiments to be implemented.

### BRIEF DESCRIPTION OF THE DRAWINGS

The accompanying drawings, which are incorporated in and constitute a part of the specification, illustrate embodiments of the present disclosure and, together with the description, serve to explain the principles of the present disclosure.

With reference to the drawings, the present disclosure will be described in more detail below:

FIG. 1 is a flowchart of some embodiments of a target pushing method of the present disclosure;

FIGS. 2a to 2d are schematic diagrams of some embodiments of a pushing page template of the present disclosure;

FIGS. 3a to 3d are schematic diagrams of some embodiments of the target pushing method of the present disclosure:

FIG. 4 is a block diagram of some embodiments of a target pushing apparatus of the present disclosure:

FIG. 5 is a block diagram of some other embodiments of the target pushing apparatus of the present disclosure; and

FIG. 6 is a block diagram of some further embodiments of the target pushing apparatus of the present disclosure.

### DETAILED DESCRIPTION OF EMBODIMENTS

Various exemplary embodiments of the present disclosure will now be described in detail with reference to the accompanying drawings. It should be noted that the relative arrangements of parts and steps, the expressions of numbers and values set forth in these embodiments do not limit the scope of the present disclosure unless specifically stated otherwise.

At the same time, it should be understood that, for ease of description, the dimensions of various parts shown in the drawings are not drawn in an actual proportional relationship.

The descriptions of at least one exemplary embodiment below are merely illustrative in nature and are in no way intended to limit the present disclosure, its application, or uses.

The technologies, methods, and apparatuses known to those of ordinary skill in the relevant art may not be discussed in detail, but in appropriate circumstances, the technologies, methods, and apparatuses should be considered as part of the specification.

In all the examples shown and discussed herein, any specific value should be construed as merely exemplary and not as a limitation. Therefore, other examples of the exemplary embodiments may have different values.

It should be noted that similar reference numerals and letters denote similar items in the following drawings, and therefore, once an item is defined in one drawing, it is not necessary to further discuss it in subsequent drawings.

The inventors of the present disclosure have found the following problems in the related art: The production cycle of the pushing page is long, and the process is complex, resulting in low efficiency of information pushing.

In view of this, the present disclosure provides a target pushing technical solution, which can improve the efficiency of information pushing.

As mentioned above, the manual editing of a pushing page has low efficiency of information pushing. For example, in a book pushing scenario, if a user wants to display related information of a pushed book on a pushing page, a picture with the related information needs to be edited outside an editor of a current pushing application, and then transmitted back to the editor. This results in a long operation chain and high production costs, thereby resulting in low efficiency of information pushing.

In view of the above technical problems, the technical solution of the present disclosure automatically matches an appropriate pushing page template and automatically generates a pushing page based on current pushing characteristics. In this way, the production cycle of the pushing page can be shortened, and the production process can be simplified, thereby improving the efficiency of information pushing. For example, the technical solution of the present disclosure may be implemented by the following embodiments.

FIG. 1 is a flowchart of some embodiments of a target pushing method of the present disclosure.

As shown in FIG. 1, in step 110, pushing information of at least one to-be-pushed target is obtained. For example, the to-be-pushed target may comprise an article (such as a book, a commodity; or clothing) or a service to be pushed; and the pushing information may comprise a topic, a post, or the like initiated to push the target.

In step 120, a pushing page template is determined based on a pushing characteristic of the pushing information. For example, the pushing page template may be a page sample matching the pushing characteristics and having a preset style and display form.

In step 130, a pushing page of the at least one to-be-pushed target is generated based on the pushing information and the pushing page template.

In the above embodiments, an appropriate pushing page template can be automatically matched and a pushing page can be automatically generated based on the pushing characteristic of the current target pushing. In this way, the production cycle of the pushing page can be shortened, and the production process can be simplified, thereby improving the efficiency of information pushing.

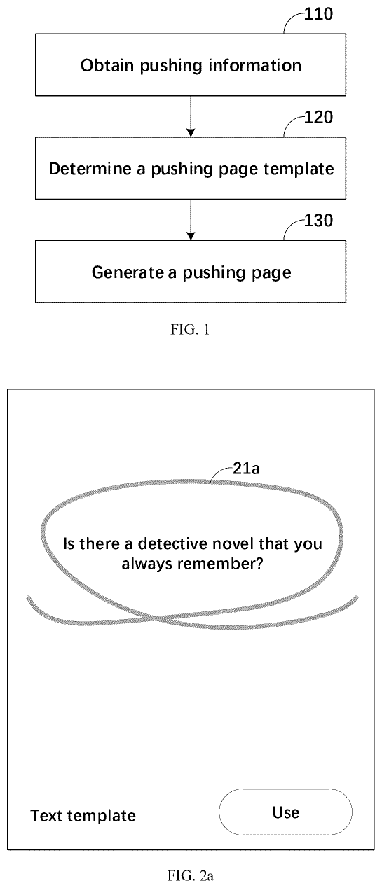

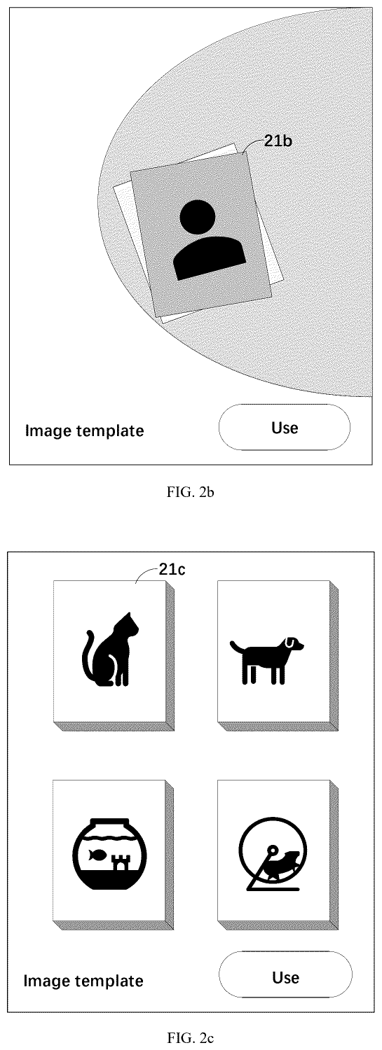

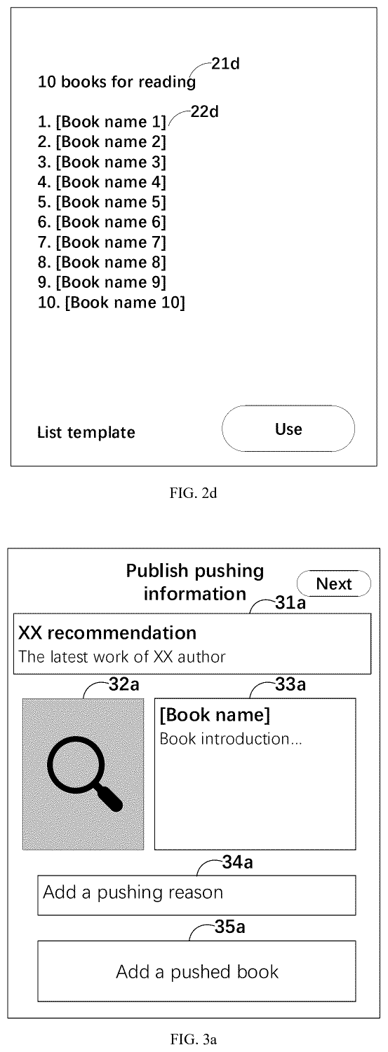

FIGS. 2a to 2d are schematic diagrams of some embodiments of a pushing page template of the present disclosure. For example, a matched pushing page template may be determined from the embodiments in FIGS. 2a to 2d based on the pushing characteristics of current pushing information.

Some embodiments are used below to describe different pushing characteristics of the pushing information.

In some embodiments, different pushing characteristics prompt different attribute features of the at least one to-be-pushed target. For example, the attribute features comprise at least one of a type to which the at least one to-be-pushed target belongs, a target producer of the at least one to-be-pushed target, an audience group aimed at by the at least one to-be-pushed target, and number information of the at least one to-be-pushed target.

For example, the attribute features comprise a type to which the to-be-pushed target belongs. Taking the to-be-pushed target as a book for example, if a user wants to initiate a book pushing topic as the pushing information of the book, and a title of the pushing topic is “Is there a detective novel that you always remember?”. The pushing topic emphasizes that the book belongs to the detective novel type, that is, the pushing characteristic of the pushing information prompts a type to which the to-be-pushed target belongs.

In this case, a text template may be determined as the pushing page template. For example, the text template shown in FIG. 2a may be determined as the pushing page template.

As shown in FIG. 2a, the text template may comprise a text display area 21a, configured to display text description information of the to-be-pushed target.

In some embodiments, the text description information may be generated based on a keyword in the pushing information. For example, the keyword may comprise type information of the to-be-pushed target. For example, the text description information may be a title “Is there a detective novel that you always remember?” obtained from the pushing topic.

For example, in response to the user selecting a trigger control (such as a “Use” control in FIG. 2a), the pushing page including the text description information is automatically generated.

In this way, the type feature of the to-be-pushed target can be directly and explicitly displayed through the text description information, thereby improving the effect of information pushing.

For example, the attribute features comprise a target producer of the to-be-pushed target. Taking the to-be-pushed target as a book for example, if a user wants to initiate a book pushing topic as the pushing information of the book, and the pushing topic is “Recommend a work of a great writer XXX”. The pushing topic emphasizes the author of the book, that is, the pushing characteristic of the pushing information prompts the target producer of the to-be-pushed target.

In this case, an image template may be determined as the pushing page template. In some embodiments, the image template comprises a single-object template being configured to display image description information of any one of the at least one to-be-pushed target. For example, the single-object template shown in FIG. 2b may be determined as the pushing page template.

As shown in FIG. 2b, the single-object template may comprise an image display area 21b, configured to display image description information of the to-be-pushed target.

In some embodiments, in response to the at least one to-be-pushed target being a single to-be-pushed target, the single-object template is determined as the pushing page template. For example, a pushing topic “Recommend a work of a great writer XXX” only recommends one book of the author, and related image of the book (such as a cover image or an illustration including the information of the target producer) may be used as the image description information and added to the image display area 21b to generate the pushing page.

In some embodiments, a background image may be generated based on the at least one to-be-pushed target by using a machine learning model; and the pushing page is generated based on the background image, the image description information of the at least one to-be-pushed target, and the page template. For example, the background image may be generated based on an attribute (such as content, type, author, or the like) of the recommended book by using the machine learning model; and the background image is used as a background of the image display area 21b to generate the pushing page.

In this way, the background image related to the to-be-pushed target can be generated to improve the display effect of the pushing page, thereby improving the effect of information pushing.

In some embodiments, in response to a number of targets displayed by the image template being less than a number of the at least one to-be-pushed target, a specified number of targets are selected from the at least one to-be-pushed target, the specified number being less than or equal to the number of targets displayed by the image template; and the pushing page is generated based on image description information of the specified number of targets and the page template.

For example, a pushing topic “Recommend several works of a great writer XXX” recommends a plurality of books of the author, and related image of one of the books may be selected from the books as the image description information and added to the image display area 21b to generate the pushing page.

In this way, the information of the producer of the to-be-pushed target can be displayed intuitively and conspicuously through the image description information, thereby improving the effect of information pushing.

For example, the attribute features comprise an audience group aimed at by the to-be-pushed target. The audience group may comprise a group with a specified age range, a group with a specified hobby, a group in a specified region, or the like, that is, a group with the same attribute feature. Taking the to-be-pushed target as a book for example, if a user wants to initiate a book pushing topic as the pushing information of the book, and the pushing topic is “Recommend several pet-related works”. The pushing topic emphasizes that the audience group of the book is a group that loves pets, that is, the pushing characteristic of the pushing information prompts the audience group aimed at by the to-be-pushed target.

In this case, an image template may be determined as the pushing page template. In some embodiments, the image template comprises a multi-object template being configured to display image description information of a plurality of targets in the at least one to-be-pushed target. For example, the multi-object template shown in FIG. 2c may be determined as the pushing page template.

As shown in FIG. 2c, the multi-object template may comprise a plurality of image display areas 21c, configured to display image description information of the plurality of to-be-pushed targets.

In some embodiments, in response to the at least one to-be-pushed target being a plurality of to-be-pushed targets, the multi-object template is determined as the pushing page template. For example, the pushing topic “Recommend several pet-related works” recommends a plurality of books, and related images of the books (such as cover images or illustrations that can reflect the audience group) may be used as the image description information and added to the image display areas 21c to generate the pushing page.

For example, the pushing topic recommends 10 books, and there are four image display areas 21c. That is, the number of the image display areas 21c is insufficient to display image description information of all the books. In this case, related images of four of the books may be selected as the image description information and added to the image display areas 21c to generate the pushing page.

In this way, the information of the audience group of the to-be-pushed target can be displayed intuitively and conspicuously through the image description information, thereby improving the effect of information pushing.

For example, the attribute features comprise number information of the to-be-pushed target. Taking the to-be-pushed target as a book for example, if a user wants to initiate a book pushing topic as the pushing information of the book, and the pushing topic is “Recommend 10 books for reading”. The pushing topic emphasizes that the number information of the books is 10, that is, the pushing characteristic of the pushing information prompts the number information of the to-be-pushed target.

In this case, a list template may be determined as the pushing page template, and the list template is configured to display a list of the plurality of to-be-pushed targets. For example, the list template shown in FIG. 2d may be determined as the pushing page template.

As shown in FIG. 2d, the list template may comprise a pushing information display area 21d, configured to display the pushing information, and a list display area 22d, configured to display the list of the to-be-pushed targets. In some embodiments, the pushing topic “Recommend 10 books for reading” recommends 10 books, and related information of the books (such as names or the like that can represent the to-be-pushed targets) may be displayed in the list display area 22d in a form of a list.

For example, the pushing topic recommends 20 books, and a number of targets that can be displayed in the list display area 22d is 10. That is, the list display area 22d is insufficient to display the related information of all the books. In this case, related information of 10 of the books may be selected and displayed in the list display area 22d to generate the pushing page.

In this way; the plurality of to-be-pushed targets can be directly displayed through the list, thereby improving the effect of information pushing.

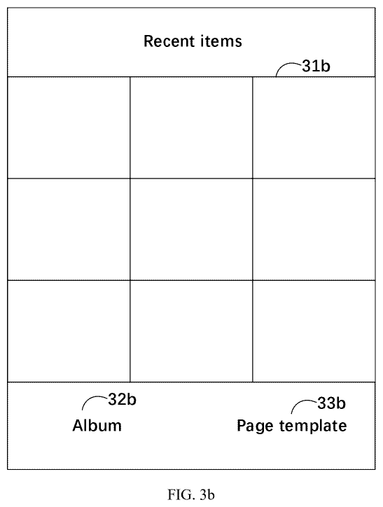

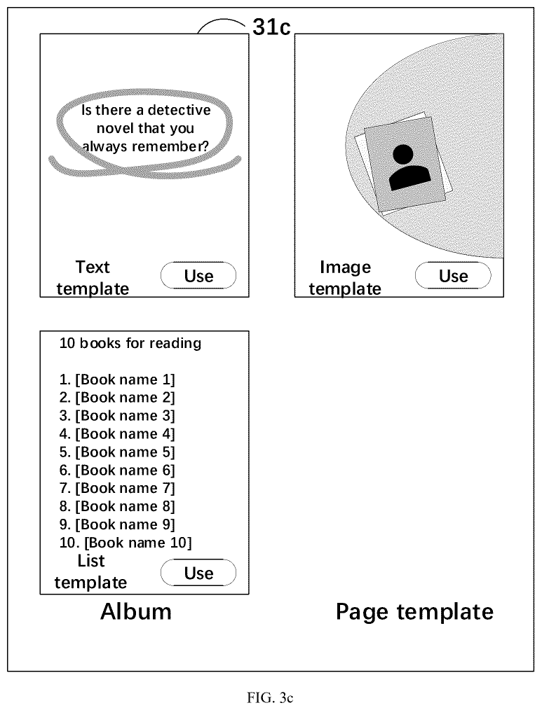

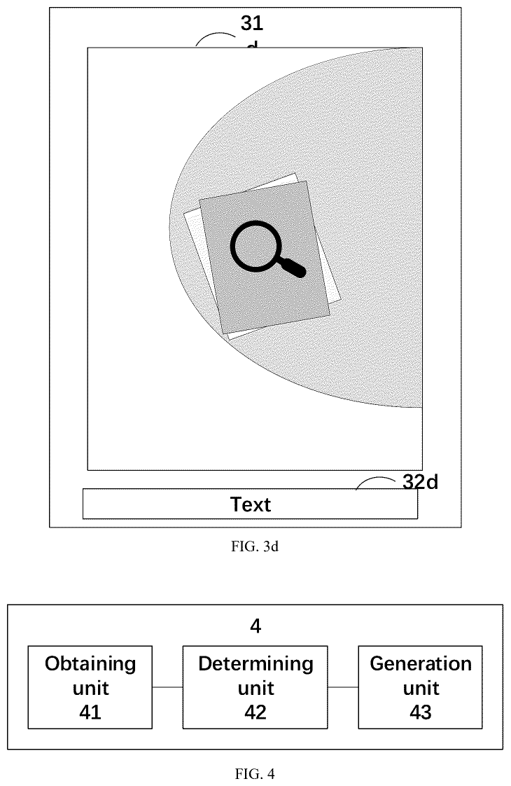

In some embodiments, a page editor may be provided for a user who posts the pushing information, to perform operations such as selection, editing, and generation on the pushing page template determined in any one of the above embodiments, so that the generated pushing page can match an actual requirement, thereby improving the effect of information pushing. For example, the above technical solution may be implemented by the embodiments in FIGS. 3a to 3d.

FIGS. 3a to 3d are schematic diagrams of some embodiments of the target pushing method of the present disclosure. As shown in FIG. 3a, an information providing interface of the page editor may be displayed to the user, and the information providing interface comprises a text display area 31a, an image display area 32a, an information display area 33a, a text entry area 34a, a target adding control 35a, and the like.

In some embodiments, text description information (such as a reason for pushing the current target) is obtained in response to a text entry operation of the user in the information providing interface; and image information is obtained in response to an object adding operation of the user in the information providing interface. For example, the user may input the text description information in the text entry area 34a, and may add the to-be-pushed target by selecting the target adding control 35a.

In some embodiments, in response to the user adding the to-be-pushed target by using the target adding control 35a, the text display area 31a displays pushing information of the to-be-pushed target, and the image display area 32a displays image information of the to-be-pushed target. For example, the text display area 31a displays a pushing topic “XX book recommendation, a latest work of an XX author” of the to-be-pushed book, and the image display area 32a displays a cover image of the to-be-pushed book.

For example, in response to the user selecting a trigger control in the information providing interface, such as a “Next” control, the page switches to a material selection interface in FIG. 3b.

As shown in FIG. 3b, the material selection interface of the page editor is used by the user to select a material type of multimedia material for generating the pushing page, and the material type may comprise an image material and a page template. For example, the material selection interface comprises an image material control 32b and a page template control 33b.

In some embodiments, a plurality of candidate multimedia materials corresponding to the material type are displayed based on the material type selected by the user in the material selection interface; and the multimedia material is determined based on the selection of the user for the plurality of candidate multimedia materials.

For example, in response to the user selecting the image material control 32b, thumbnails of images and videos in a user album may be displayed in an image display area 31b as the candidate multimedia materials for the user to select; and in response to the user selecting a thumbnail, the thumbnail may be used as the multimedia material for generating the pushing page. A trigger control of an image acquisition device may further be displayed in the image display area 31b, to open the image acquisition device of the user device.

For example, in response to the user selecting the page template control 33b, the page may switch to a template selection interface shown in FIG. 3c, and a pushing page template determined based on the pushing characteristic is displayed as the candidate multimedia material for the user to select; and in response to the selection of the user, the pushing page template may be used as the multimedia material for generating the pushing page.

As shown in FIG. 3c, in the template selection interface of the page editor, the user is prompted to select the pushing page template; and the pushing page is generated based on the pushing information and the pushing page template in response to a selection operation of the user for the pushing page template in the template selection interface. For example, the template selection interface is configured to display a plurality of candidate page templates, the plurality of candidate page templates comprise the pushing page template, and the pushing page template is highlighted.

In this way; the user can be prompted of the pushing page template matching the current to-be-pushed target, thereby improving the generation efficiency of the pushing page and the efficiency of information pushing.

For example, the plurality of candidate page templates may be displayed in a template display area 31c of the template selection interface, and the plurality of candidate page templates comprise the text template and the image template determined based on the pushing characteristic, and may further comprise a list template different from the text template and the image template. The text template and the image template may be highlighted, for example, the text template and the image template may be displayed at the front of the list template, or the text template and the image template may be displayed in a highlighted manner or indicated by using a special icon.

In some embodiments, the template selection interface is configured to display the plurality of candidate page templates based on a number of the at least one to-be-pushed target.

For example, the template selection interface is configured to perform at least one of the following: display at least one of a single-object template or a text template in response to the at least one to-be-pushed target being a single to-be-pushed target: or display at least one of a multi-object template or a list template in response to the at least one to-be-pushed target being a plurality of to-be-pushed targets.

For example, in accordance with a determination, based on the pushing information, that the number of to-be-pushed books is one, the single-object template or the text template may be displayed in the template display area 31c: or in accordance with a determination, based on the pushing information, that the number of to-be-pushed books is six, the multi-object template or the list template may be displayed in the template display area 31c.

For example, the template selection interface is configured to perform at least one of the following: in response to the at least one to-be-pushed target being the single to-be-pushed target, the plurality of candidate page templates do not comprise the multi-object template, or at least one of the single-object template or the text template is highlighted in the plurality of candidate page templates.

For example, in accordance with a determination, based on the pushing information, that the number of to-be-pushed books is one, only the single-object template or the text template may be displayed in the template display area 31c, and the multi-object template is not displayed: or in the template display area 31c, the single-object template or the text template is displayed in front, and the multi-object template is displayed behind.

For example, the template selection interface is configured to perform at least one of the following: in response to a number of the plurality of to-be-pushed targets being less than a threshold, the multi-object template is highlighted in the plurality of candidate page templates: or in in response to the number of the plurality of to-be-pushed targets being greater than or equal to the threshold, the list template is highlighted in the plurality of candidate page templates. For example, in accordance with a determination, based on the pushing information, that the number of to-be-pushed books is six, and the number of the to-be-pushed targets is less than a threshold 10, the multi-object template may be displayed in front, in the template display area 31c; or in accordance with a determination, based on the pushing information, that the number of to-be-pushed books is 10, and the number of the to-be-pushed targets is equal to the threshold 10, the list template may be displayed in front, in the template display area 31c.

In this way, the user can be prompted of the pushing page template that can most intuitively display the to-be-pushed target based on the number of the to-be-pushed targets, thereby improving the generation efficiency of the pushing page and the efficiency of information pushing.

In some embodiments, a candidate pushing page of the at least one to-be-pushed target is generated based on the pushing information and the pushing page template; and the pushing page is generated based on edit information provided by the user in an edit interface of the candidate pushing page. For example, the above technical solution may be implemented by the edit interface in FIG. 3d.

As shown in FIG. 3d, the edit interface of the page editor may comprise a page display area 31d, configured to display the candidate pushing page generated based on the previously determined pushing page template; and may further comprise a text edit area 32d, configured to add the edit information to the candidate pushing page.

For example, the edit information comprises at least one of text information input by the user in the edit interface or candidate edit information selected by the user; and the candidate edit information may comprise a preset pushing keyword. In this way, description information matching the to-be-pushed target can be quickly generated, thereby improving the efficiency of information pushing.

In some embodiments, in response to a number of the to-be-pushed target being greater than a number of targets that can be displayed by the page pushing template, a candidate pushing page displayed in the page display area 31d may be generated based on a to-be-pushed target first added by the user in the information providing interface in FIG. 3a.

For example, the user adds X books in the information providing interface: in response to selecting the single-object template to generate the pushing page, the single-object template may be rendered based on a first book added by the user: in response to selecting the multi-object template that can display N₁ targets to generate the pushing page, the multi-object template may be rendered based on first N₁ books added by the user: or in response to selecting the list template that can display N₂ targets to generate the pushing page, the list template may be rendered based on the text description information input by the user and first N₂ books added by the user.

In this way, the generated pushing page can display description information of a key target in the plurality of to-be-pushed targets, thereby improving the efficiency of information pushing.

FIG. 4 is a block diagram of some embodiments of a target pushing apparatus of the present disclosure.

As shown in FIG. 4, a target pushing apparatus 4 comprises: an obtaining unit 41 configured to obtain pushing information of at least one to-be-pushed target: a determining unit 42 configured to determine a pushing page template based on a pushing characteristic of the pushing information; and a generation unit 43 configured to generate a pushing page of the at least one to-be-pushed target based on the pushing information and the pushing page template.

In some embodiments, different pushing characteristics prompt different attribute features of the at least one to-be-pushed target.

In some embodiments, the attribute features comprise at least one of a type to which the at least one to-be-pushed target belongs, a target producer of the at least one to-be-pushed target, an audience group aimed at by the at least one to-be-pushed target, and number information of the at least one to-be-pushed target.

In some embodiments, the determining unit 42 determines, in response to the pushing characteristic being configured to prompt that the at least one to-be-pushed target belongs to a same type, a text template as the pushing page template, and the text template is configured to display text description information of the at least one to-be-pushed target.

In some embodiments, the text description information is generated based on a keyword in the pushing information.

In some embodiments, the determining unit 42 determines, in response to the pushing characteristic being configured to prompt that the at least one to-be-pushed target belongs to a same target producer or the at least one to-be-pushed target is aimed at audience groups of a same type, an image template as the pushing page template, and the image template is configured to display image description information of the at least one to-be-pushed target.

In some embodiments, the generation unit 43 selects, in response to a number of targets displayed by the image template being less than a number of the at least one to-be-pushed target, a specified number of targets from the at least one to-be-pushed target, the specified number being less than or equal to the number of targets displayed by the image template; and generates the pushing page based on image description information of the specified number of targets and the page template.

In some embodiments, the generation unit 43 generates a background image based on the at least one to-be-pushed target by using a machine learning model, and generates the pushing page based on the background image, the image description information of the at least one to-be-pushed target, and the page template.

In some embodiments, the image template comprises a single-object template being configured to display image description information of any one of the at least one to-be-pushed target and a multi-object template being configured to display image description information of a plurality of targets in the at least one to-be-pushed target.

In some embodiments, the determining unit 42 determines, in response to the at least one to-be-pushed target being a single to-be-pushed target, the single-object template as the pushing page template; and determines, in response to the at least one to-be-pushed target being a plurality of to-be-pushed targets, the multi-object template as the pushing page template.

In some embodiments, the determining unit 42 determines, in response to the pushing characteristic being configured to prompt that the at least one to-be-pushed target comprises a plurality of to-be-pushed targets, a list template as the pushing page template, and the list template is configured to display a list of the plurality of to-be-pushed targets.

In some embodiments, the generation unit 43 prompts a user to select the pushing page template in a template selection interface; and generates the pushing page based on the pushing information and the pushing page template in response to a selection operation of the user for the pushing page template in the template selection interface.

In some embodiments, the template selection interface is configured to display a plurality of candidate page templates, the plurality of candidate page templates comprise the pushing page template, and the pushing page template is highlighted.

In some embodiments, the template selection interface is configured to display the plurality of candidate page templates based on a number of the at least one to-be-pushed target.

In some embodiments, the template selection interface is configured to perform at least one of the following: display at least one of a single-object template or a text template in response to the at least one to-be-pushed target being a single to-be-pushed target: or display at least one of a multi-object template or a list template in response to the at least one to-be-pushed target being a plurality of to-be-pushed targets.

In some embodiments, the template selection interface is configured to perform at least one of the following: in response to the at least one to-be-pushed target being the single to-be-pushed target, the plurality of candidate page templates do not comprise the multi-object template, or at least one of the single-object template or the text template is highlighted in the plurality of candidate page templates.

In some embodiments, the template selection interface is configured to perform at least one of the following: in response to a number of the plurality of to-be-pushed targets being less than a threshold, the multi-object template is highlighted in the plurality of candidate page templates: or in response to the number of the plurality of to-be-pushed targets being greater than or equal to the threshold, the list template is highlighted in the plurality of candidate page templates.

In some embodiments, the generation unit 43 generates a candidate pushing page of the at least one to-be-pushed target based on the pushing information and the pushing page template; and generates the pushing page based on edit information provided by the user in an edit interface of the candidate pushing page.

In some embodiments, the edit information comprises at least one of text information input by the user in the edit interface or candidate edit information selected by the user.

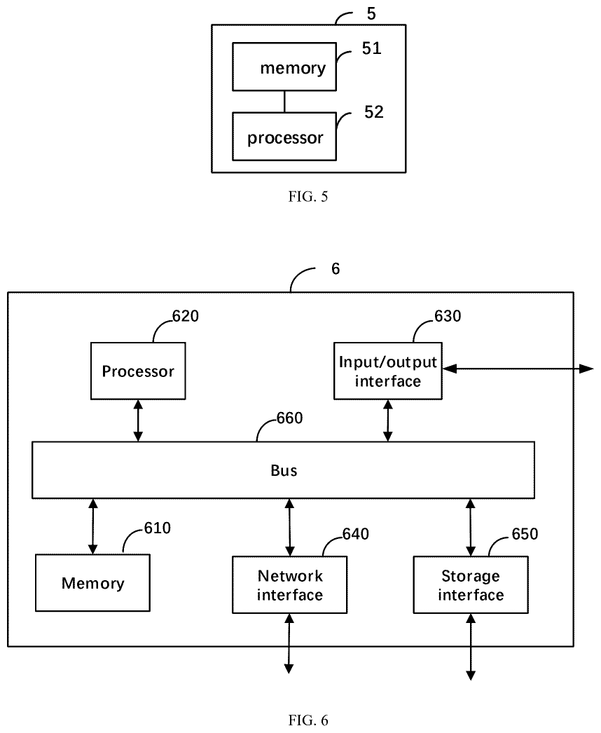

FIG. 5 is a block diagram of some other embodiments of the target pushing apparatus of the present disclosure.

As shown in FIG. 5, a target pushing apparatus 5 in this embodiment comprises: a memory 51 and a processor 52 coupled to the memory 51, wherein the processor 52 is configured to execute the target pushing method in any one of the embodiments of the present disclosure based on instructions stored in the memory 51.

The memory 51 may comprise, for example, a system memory; a fixed non-volatile storage medium, or the like. The system memory stores, for example, an operating system, an application, a boot loader (Boot Loader), a database, and other programs.

FIG. 6 is a block diagram of some further embodiments of the target pushing apparatus of the present disclosure.

As shown in FIG. 6, a target pushing apparatus 6 in this embodiment comprises: a memory 610 and a processor 620 coupled to the memory 610, wherein the processor 620 is configured to execute the target pushing method in any one of the foregoing embodiments based on instructions stored in the memory 610.

The memory 610 may comprise, for example, a system memory; a fixed non-volatile storage medium, or the like.

The system memory stores, for example, an operating system, an application, a boot loader (Boot Loader), and other programs.

The target pushing apparatus 6 may further comprise an input/output interface 630, a network interface 640, a storage interface 650, and the like. These interfaces 630, 640, and 650, the memory 610, and the processor 620 may be connected through a bus 660, for example. The input/output interface 630 provides a connection interface for input/output devices such as a display; a mouse, a keyboard, a touchscreen, a microphone, and a speaker. The network interface 640 provides a connection interface for various networked devices. The storage interface 650 provides a connection interface for external storage devices such as an SD card and a USB flash disk.

Those skilled in the art should understand that the embodiments of the present disclosure may be provided as a method, a system, or a computer program product. Therefore, the present disclosure may be implemented in the form of a complete hardware embodiment, a complete software embodiment, or an embodiment combining software and hardware. Moreover, the present disclosure may be implemented in the form of a computer program product implemented on one or more computer-usable non-transitory storage media (including but not limited to a magnetic disk memory, a CD-ROM, and an optical memory) containing computer-usable program codes.

So far, the target pushing method, the target pushing apparatus, and the computer-readable storage medium according to the present disclosure have been described in detail. In order to avoid obscuring the concept of the present disclosure, some details well known in the art are not described. Those skilled in the art can fully understand how to implement the technical solution disclosed herein according to the above description.

The method and system of the present disclosure may be implemented in many ways. For example, the method and system of the present disclosure may be implemented by software, hardware, firmware, or any combination of software, hardware, and firmware. The above sequence of the steps of the method is merely for illustration, and the steps of the method of the present disclosure are not limited to the specific sequence described above, unless otherwise specified. In addition, in some embodiments, the present disclosure may also be implemented as a program recorded in a recording medium, where the program includes machine-readable instructions for implementing the method according to the present disclosure. Therefore, the present disclosure also covers a recording medium storing a program for executing the method according to the present disclosure.

Although some specific embodiments of the present disclosure have been described in detail through examples, those skilled in the art should understand that the above examples are for illustration only, rather than limiting the scope of the present disclosure. Those skilled in the art should understand that the above embodiments may be modified without departing from the scope and spirit of the present disclosure. The scope of the present disclosure is defined by the appended claims.

1. A target pushing method, comprising:
obtaining pushing information of at least one to-be-pushed target;
determining a pushing page template based on a pushing characteristic of the pushing information; and
generating a pushing page of the at least one to-be-pushed target based on the pushing information and the pushing page template.

2. The target pushing method according to claim 1, wherein different pushing characteristics prompt different attribute features of the at least one to-be-pushed target.

3. The target pushing method according to claim 2, wherein:
the attribute features comprise at least one of a type to which the at least one to-be-pushed target belongs, a target producer of the at least one to-be-pushed target, an audience group aimed at by the at least one to-be-pushed target, or number information of the at least one to-be-pushed target; and/or
the determining the pushing page template comprises: determining a text template as the pushing page template, in response to the pushing characteristic being configured to prompt that the at least one to-be-pushed target belongs to a same type, the text template being configured to display text description information of the at least one to-be-pushed target.

4. The target pushing method according to claim 3, wherein the text description information is generated based on a keyword in the pushing information.

5. The target pushing method according to claim 2, wherein the determining the pushing page template comprises:
determining an image template as the pushing page template, in response to the pushing characteristic being configured to prompt that the at least one to-be-pushed target belongs to a same target producer or the at least one to-be-pushed target aims at audience groups of a same type, the image template being configured to display image description information of the at least one to-be-pushed target.

6. The target pushing method according to claim 5, wherein the generating the pushing page of the at least one to-be-pushed target comprises:
selecting a specified number of targets from the at least one to-be-pushed target, in response to a number of targets displayed by the image template being less than a number of the at least one to-be-pushed target, the specified number being less than or equal to the number of targets displayed by the image template; and
generating the pushing page based on image description information of the specified number of targets and the page template.

7. The target pushing method according to claim 6, wherein the generating the pushing page comprises:
generating a background image based on the at least one to-be-pushed target by using a machine learning model; and
generating the pushing page based on the background image, the image description information of the at least one to-be-pushed target, and the page template.

8. The target pushing method according to claim 5, wherein the image template comprises a single-object template being configured to display image description information of any one of the at least one to-be-pushed target and a multi-object template being configured to display image description information of a plurality of targets in the at least one to-be-pushed target.

9. The target pushing method according to claim 8, wherein the determining the pushing page template comprises:
determining the single-object template as the pushing page template, in response to the at least one to-be-pushed target being a single to-be-pushed target; and
determining the multi-object template as the pushing page template, in response to the at least one to-be-pushed target being a plurality of to-be-pushed targets.

10. The target pushing method according to claim 2, wherein the determining the pushing page template comprises:
determining a list template as the pushing page template, in response to the pushing characteristic being configured to prompt that the at least one to-be-pushed target comprises a plurality of to-be-pushed targets, the list template being configured to display a list of the plurality of to-be-pushed targets.

11. The target pushing method according to claim 1, wherein the generating the pushing page of the at least one to-be-pushed target comprises:
prompting a user to select the pushing page template in a template selection interface; and
generating the pushing page based on the pushing information and the pushing page template, in response to a selection operation of the user for the pushing page template in the template selection interface.

12. The target pushing method according to claim 11, wherein the template selection interface is configured to display a plurality of candidate page templates, the plurality of candidate page templates comprise the pushing page template, and the pushing page template is highlighted.

13. The target pushing method according to claim 12, wherein the template selection interface is configured to display the plurality of candidate page templates based on a number of the at least one to-be-pushed target.

14. The target pushing method according to claim 13, wherein the template selection interface is configured to perform at least one of the following:
display at least one of a single-object template or a text template in response to the at least one to-be-pushed target being a single to-be-pushed target; or
display at least one of a multi-object template or a list template in response to the at least one to-be-pushed target being a plurality of to-be-pushed targets.

15. The target pushing method according to claim 14, wherein the template selection interface is configured to perform at least one of the following:
the plurality of candidate page templates do not comprise the multi-object template, or at least one of the single-object template or the text template is highlighted in the plurality of candidate page templates, in response to the at least one to-be-pushed target being the single to-be-pushed target.

16. The target pushing method according to claim 14, wherein the template selection interface is configured to perform at least one of the following:
the multi-object template is highlighted in the plurality of candidate page templates, in response to a number of the plurality of to-be-pushed targets being less than a threshold; or
the list template is highlighted in the plurality of candidate page templates, in response to the number of the plurality of to-be-pushed targets being greater than or equal to the threshold.

17. The target pushing method according to claim 1, wherein the generating the pushing page of the at least one to-be-pushed target comprises:
generating a candidate pushing page of the at least one to-be-pushed target based on the pushing information and the pushing page template; and
generating the pushing page based on edit information provided by a user in an edit interface of the candidate pushing page.

18. The target pushing method according to claim 17, wherein the edit information comprises at least one of text information entered by the user in the edit interface or candidate edit information selected by the user.

19. A target pushing apparatus, comprising:
a memory; and
a processor coupled to the memory, the processor being configured to execute a target pushing method based on instructions stored in the memory, wherein the target pushing method comprises:
obtaining pushing information of at least one to-be-pushed target;
determining a pushing page template based on a pushing characteristic of the pushing information; and
generating a pushing page of the at least one to-be-pushed target based on the pushing information and the pushing page template.

20. A non-transitory computer-readable storage medium having a computer program stored thereon, wherein the program, when executed by a processor, causes a target pushing method to be implemented, wherein the target pushing method comprises:
obtaining pushing information of at least one to-be-pushed target;
determining a pushing page template based on a pushing characteristic of the pushing information; and
generating a pushing page of the at least one to-be-pushed target based on the pushing information and the pushing page template.
